(19) United States
(12) Patent Application Publication
(10) Pub. No.: US 2003/0079383 A1
(43) Pub. Date: May 1, 2003

(54) Identification tag module for inkjet printers

(76) Inventors: Jeffrey R. Blackman, Vancouver, WA (US); Richard A. Kelley, Vancouver, WA (US); Rachel Kuller, Vancouver, WA (US); Matt G. Driggers, Vancouver, WA (US)

Correspondence Address: HEWLETT-PACKARD COMPANY, Intellectual Property Administration, P.O. Box 272400, Fort Collins, CO, 80527-2400, US

(21) Appl. No.: 10/021,480

(22) Filed: Oct. 30, 2001

(51) Int. Cl. G09F 3/10; A44C 5/00

(52) U.S. Cl. 40/299.01; 40/633

(57) ABSTRACT

Identification tag media originates in reel-form and feeds through a conventional inkjet printer. A modified media infeed tray holds a reel of such identification tag media positioned for collection by the printer media transport mechanism. The identification tag media passes by the inkjet print head to receive print imaging thereon in the form of identification indicia. Thus, length segments of identification tag media may be severed into identification tag bracelets and coupled to users by encircling limbs and joining as by use of clasps.

### BACKGROUND OF THE INVENTION

The present invention relates generally to printing devices, and particularly to printing devices producing as output identification tag media.

An identification tag is typically printed indicia prepared for a particular individual. For example, hospitals use identification tags for patients. Participants in conventions and meetings often receive identification tags to facilitate introductions among participants. In most cases, therefore, each identification tag is unique to a particular individual and printed specifically for that individual. Identification tag production, however, often involves mass production of identification tags. In other words, the context for identification tag use typically involves a relatively large number of individuals and, therefore, a relatively large number of identification tags need be produced with each tag corresponding to a particular individual.

Various methods and apparatus have evolved in implementation of identification tag production and use. For example, conventional adhesive labels can be printed using conventional printing devices, e.g., sheet-form adhesive labels fed through the paper transport path of a conventional printer. Once produced, i.e., printed material applied to the labels, the labels apply directly as identification tags. More particularly, individuals receiving the printed labels simply press the adhesive side of the label against their clothing to display the identifying material, i.e. material unique to that individual and provided as an identification tag. Unfortunately, such identification tags lack significant reusability and lack any security.

Security can be an important requirement when producing and using identification tags. Positive identification is important across a spectrum of applications. For example, a patient in a hospital should be positively identified by identification tag. Persons wearing certain identification tags may be permitted access to restricted areas in a concert or entertainment event. As may be appreciated, security becomes critical in applications involving access to highly restricted office or laboratory buildings and the like. As such, only the person for whom an identification tag has been prepared should be allowed to use the identification tag. The structure and method of attaching the identification tag should be secure enough to prevent unauthorized use of the identification tag by others, i.e., prevent use by one other than the particular individual for whom the identification tag had been prepared. The structure of the identification tag itself prevents unauthorized use when removal necessitates complete or partial destruction thereof. For example, many identification tags do not survive removal and thereby indicate unauthorized use when presented in a degraded or partially destroyed condition.

It would be desirable to support high production levels when producing identification tags. Each tag typically bears unique information, i.e., information specific to the individual for whom the identification tag has been prepared. Printing identification tags is often a mass production or ongoing daily process. For example, consider preparation of a large number of identification tags for participants at a convention or large meeting. Hospitals routinely produce identification tags for each newly admitted patient. It would be desirable to allow production of identification tags by conventional, i.e., standard commercially available, printers. Such capability allows production of identification tags in various applications such as concerts, beer gardens, travel groups, restricted access areas and even as hospital identification tags. It would be also desirable to support a range of printing capability relative to the identification tag including multi-color and multi-font printing as well as graphics including image presentation such as in photographic imaging applications. Use of substantially conventional printers to produce identification tags would support such printing capabilities and thereby make desirable the use of a conventional printer as an identification tag production device.

Unfortunately, conventional printers are relatively limited in their ability to produce acceptable identification tags, i.e., generally limited to production of conventional adhesive labels as by sheet-form label printing techniques. As a result, such labels have limited utility as identification tags due to their inconvenient mass production capability, limited reusability, and almost complete lack of security features.

Media size plays an important role in identification tag production, especially with respect with use of conventional printer. More particularly, some identification tags are substantially smaller than the lower size limit allowed for most conventional printers. Accordingly, sheet-form label printing operations are often the only available choice for producing such small-sized labels on conventional printers. In other words, an array of strip-form identification tag labels come on a waxy back sheet capable of passing through a printer. Application of print imaging, i.e., identifying information, on the array of labels provides an array of adhesive-bearing strip-form identification tags.

A particularly popular and useful type of identification tag comes in the form of a strip, i.e., a strip-form identification tag, of substantially narrow width and of sufficient length to encircle, for example, the person's wrist. Often, such strip-form labels are produced in sheet-form paper media and removed therefrom for placement within or adhesion to a plastic sheath forming the remainder of the identification tag, i.e., forming a bracelet holding the printed paper media therein or thereon. Unfortunately, conventional printers offer little efficiency with respect to production of strip-form identification tags, especially when such tags are ultimately placed in or on protective sheaths for security purposes. In other words, such identification tag manufacture is labor intensive in requiring manipulation of individual labels as produced by the printer and, further, individual placement of each strip within or upon the protective sheath. It would be desirable, therefore, to support more efficient, less manually intensive mass production of identification tags.

Thus, conventional identification tag printing methods, particularly with respect to strip-form media, includes printing of identification indicia on strips of media and thereafter placing the printed strips in or on holders for attachment to the wearer. It would be desirable to more efficiently produce identification tags, especially if a conventional printer can be employed to substantially complete the identification tag production process.

### SUMMARY OF THE INVENTION

The present invention proposes use of reel-form media fed lengthwise into the paper feed mechanism of an inkjet printer. Such reel-form media provides as output a series of identification tags, each bearing unique identification indicia, produced by substantially conventional inkjet printer technology. According to one aspect of the present invention, an inkjet printer media input module includes a module attachable to the inkjet printer and a reel-form media support presenting to the inkjet paper transport mechanism a distal end of the reel-form media. According to another aspect of the present invention, an identification tag includes a length section of substrate having a fold line therealong. One lateral side of the section receives print imaging and the other lateral side receives an adhesive. By folding over the substrate at the fold line, one captures, i.e., traps between the lateral sides, the print imaging and the adhesive to form an identification tag. Print imaging is protected against abrasion and water damage within, according to one aspect of the present invention, a transparent substrate. In this manner, identification indicia provided as print imaging is both tamper-resistant and damage-resistant in use. An identification tag printing operation according to the present invention includes a conventional inkjet printer and a module adapted to feed reel-stock media through the conventional feed mechanism of the inkjet printer. The output, taken as separate segments or as a series of connected segments remaining attached end-to-end, may be reproduced in large quantities by use of conventional inkjet printer.

The subject matter of the present invention is particularly pointed out and distinctly claimed in the concluding portion of this specification. However, both the organization and method of operation of the invention, together with further advantages and objects thereof, may best be understood by reference to the following description taken with the accompanying drawings wherein like reference characters refer to like elements.

### BRIEF DESCRIPTION OF THE DRAWINGS

For a better understanding of the invention, and to show how the same may be carried into effect, reference will now be made, by way of example, to the accompanying drawings in which:

FIG. 1 (Prior Art) illustrates a conventional infeed tray.

FIG. 2 (Prior Art) illustrates schematically the infeed tray of FIG. 1 and a conventional printer operating in coordination therewith to collect media for application of print imaging thereon.

FIG. 3 illustrates schematically the printer of FIG. 2 operating in coordination with an identification tag module according to one embodiment of the present invention.

FIG. 4 illustrates schematically and in perspective the identification tag module of FIG. 2.

FIG. 5 illustrates in side view an identification tag bracelet produced in accordance with the present invention.

FIG. 6 illustrates a source of media used to produce identification tags according to the present invention.

FIG. 7 illustrates an identification tag as produced from the media of FIG. 6 in accordance with the present invention.

FIGS. 8 and 9 illustrate end and face views, respectively, of an identification tag produced in accordance with the present invention.

FIG. 10 illustrates schematically a suggested form of cutter 130 used in conjunction with an implementation of the present invention.

### DETAILED DESCRIPTION OF THE PREFERRED EMBODIMENT

The present invention proposes use of a reel-stock identification tag media fed into a conventional printer. For example, many printers include auxiliary media input such as slots for inserting individual items. Most common, however, is a media input tray holding a stack of media and supporting automated sequential infeed of media through a printer. For example The Hewlett-Packard Company Inkjet Printer Models DeskJet 970 and DeskJet 990 include a media input tray. According to the present invention, such a conventional media input tray can be replaced by an identification tag module carrying as a media source identification tag media in reel-form fed into the printer, through the paper transport mechanism, and past a print zone. A module, under one aspect of the present invention, includes a spool of bracelet media with the spool positioned relative to the feed system of the printer to allow the printer to collect the bracelet media from the spool and carry the bracelet media therethrough. A small, e.g., 0.8 inch (2.03 cm) wide, media is contemplated for many bracelet identification tag applications. For such small-width media, a wider “starter card” attached as a leader facilitates introduction into conventional inkjet media feed mechanisms.

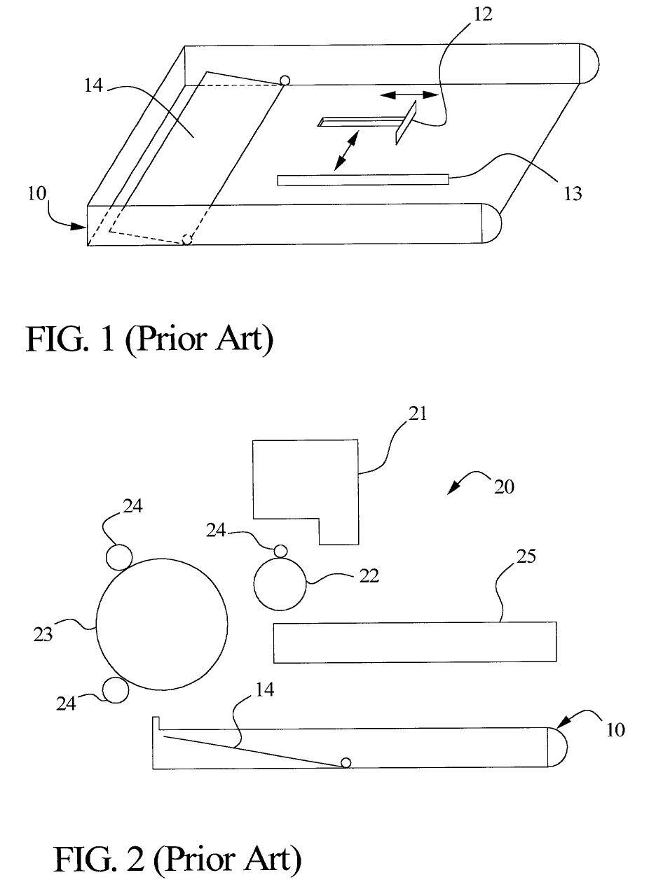

FIG. 1 (Prior Art) illustrates a conventional infeed tray 10. Infeed tray 10 includes internal adjustable structures adapted for various media sizes. For example, infeed tray 10 includes a length adjustment wall 12, a width adjustment wall 13, and a paper lift 14. Adjust walls 12 and 13 are moveable longitudinally and laterally, respectively, within tray 10 to accommodate a stack of media of given size. Paper lift 14 lifts a stack of media within tray 10 upward and against a pick and feed mechanism as described more fully hereafter.

FIG. 2 (Prior Art) illustrates schematically infeed tray 10 as positioned within a conventional printer 20. Printer 20 includes a feed roller 22, pick roller 23, pinch rollers 24, and output tray 25. Infeed tray 10 sits in position within printer 20 relative to pick roller 23 such that paper lift 14 of infeed tray 10 (FIG. 1) lifts a stack of media upward and against pick roller 23. As is well known in art, pick roller 23 and pinch rollers 24 collect and carry the top member of a stack of media within tray 10 along a feed path within printer 20. Eventually, media reaches feed roller 22 as it passes by an inkjet print head 21. As may be appreciated, inkjet print head 21 reciprocates laterally on a carriage (not shown) and applies print imaging to media as feed roller 22 propels media therepast. Once print imaging has been applied, the media lands on output tray 25.

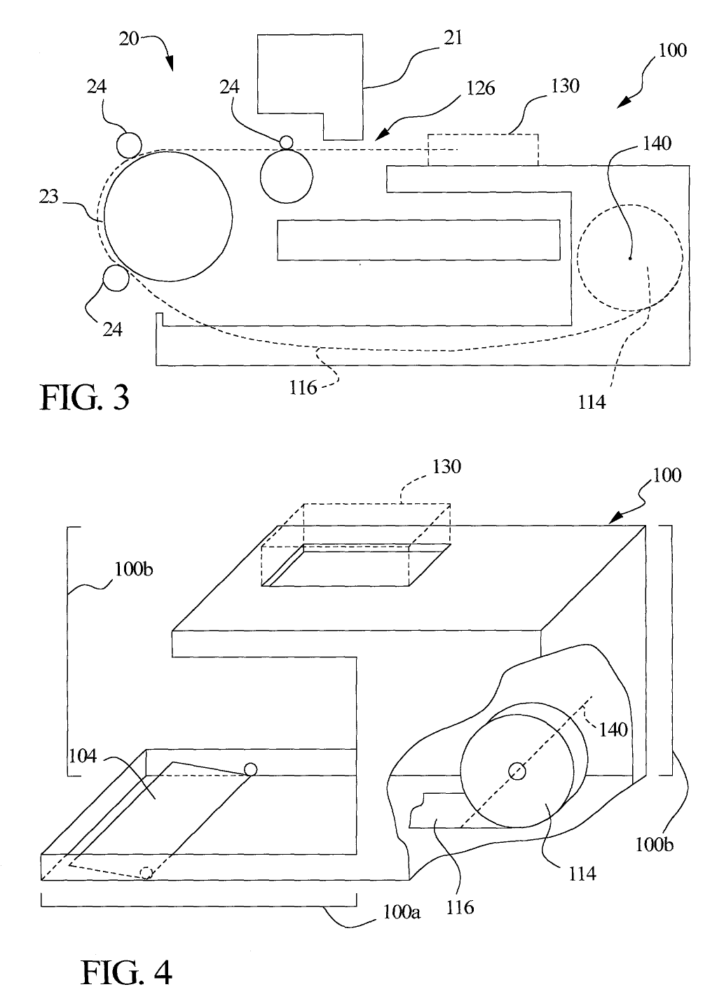

FIG. 3 illustrates schematically and in side view use of an identification tag module 100 as coupled to conventional inkjet printer 20 in place of tray 10. Module 100 includes an identification tag media spool 114. Media spool 114 carries thereon bracelet media 116. As bracelet media 116 deploys from module 100, pick roller 23 of printer 20 carries media 116 into printer 20 along the feed path as established by pick roller 23, pinch rollers 24, and feed roller 22. As media 116 moves through printer 20, it encounters a print zone 126 adjacent inkjet print head 21. Inkjet print head 21 applies print imaging as identification indicia thereto and printer 20 advances media 116 accordingly. After printing a given segment of media 116 as an identification bracelet, a cutter/punch 130 severs the newly printed bracelet identification tag from the remaining media 116 and thereby releases the newly printed bracelet identification tag relative to module 100 and printer 20. Cutter/punch 130 may take a variety of forms depending on the particular implementation of the present invention. In FIGS. 3 and 4, therefore, cutter/punch 130 will be illustrated in block form, it being understood that cutter/punch 130 may be employed as an automated processing device or as a manually operated processing device, or may be omitted under certain uses of the present invention. Locating cutter/punch 130 at the output site for printer 20 provides opportunity to segment media 116 into appropriate lengths for use as bracelet identification tags and, if necessary, to punch rivet holes.

FIG. 4 illustrates in perspective, and partially broken away, the identification tag module 100. In FIG. 4, module 100 includes identification tag media spool 114 and bracelet media 116 as taken therefrom. As may appreciated, spool 114 rotates about and is supported at an axis 140. Module 100 includes a paper lift 104, i.e., a spring bias surface positioned to urge upward media 116 against pick roller 23 of printer 20. Module 100 includes a forward portion 100a generally similar in dimension and features relative to that of conventional infeed tray 10. In other words, portion 100a of module 100 fits into the same receiving area of printer 20 as does conventional input tray 10. In this manner, module 100 mounts in the fashion of a conventional infeed tray. An upper portion 100b of module 100 provides a support surface where media 116 arrives as output exiting printer 20 and provides a support area for cutter/punch 130. Thus, output from printer 20 as taken from module 100 bears print imaging after passing through zone 126 of printer 20 and arriving at cutter/punch 130. A user then has opportunity to activate cutter/punch 130 to sever a segment of media and thereby create an identification tag bracelet. The user does not, however, necessarily use cutter/punch 130 during production of identification tag bracelets under the present invention. More particularly, the user may choose not to utilize cutter/punch 130 when initially producing an inventory of identification bracelets. The inventory of bracelets thereby remains attached and in sequential order for storage or shipment. To mount module 100, one simply removes the conventional infeed tray 10 and inserts module 100. As may be appreciated, media 116 should be positioned, i.e., advanced, within module 100 for suitably engaging pick roller 23 of printer 20 and thereby facilitating infeed of media 116 into and through printer 20. For laterally-narrow embodiments of media 116, e.g., too narrow to be initially collected by the picking mechanism of printer 20, a leader card (not shown) of greater width can be attached at the distal end of media 116 to facilitate initial takeup into printer 20. Once a sufficient length of media 116 occupies the feed path of printer 20, conventional feed mechanisms within printer 20 draw media 116 from module 100, into printer 20, and past print head 21.

With respect to the lateral position for media 116 within printer 20, it will be understood that inkjet print head 21 desirably reciprocates along a relatively shorter lateral scan path. Thus, sensors, as are well known in the art, locate the lateral edges of media 116 within printer 20 and suitably identify a lateral scan path for inkjet print head 21 according to the detected position and width of media 116. Print job formatting and printer 20 control, e.g., as originating from a host computer driving printer 20, may take into account a predetermined location for media 116, i.e., a predetermined lateral position, or may receive positional information from sensors (not shown) of printer 20 reporting the detected lateral position and width of media 116. In any case, it is understood that locating a lateral position and width for media 116 and adapting printing operations to apply print imaging within a laterally-shortened print zone suitable for media 116 is known in the art. U.S. Pat. No. 6,158,344 issued Dec. 12, 2000 and entitled Line Feed Calibration Using An Integrated Optical Sensor discloses method of calibrating a media advance mechanism in a printer using an optical sensor of the printer to detect printed marks on a calibration sheet. U.S. Pat. No. 6,244,682 issued Jun. 12, 2001 and entitled Method And Apparatus For Establishing Ink-Jet Print Head Operating Energy From An Optical Determination Of Turn-On Energy also relates to use of the sensors and inkjet print head operation in response thereto.

It is suggested that module 100 include an identification interface communicating to printer 20 its presence when inserted therein. By identifying to printer 20 the presence of a module 100, control circuitry and programming of printer 20 as well as formatting software delivering print imaging data to printer 20 takes into account the presence of module 100 and thereby suitably formats and delivers print imaging data to printer 20 and suitably operates printer 20 as described herein to produce identification bracelets.

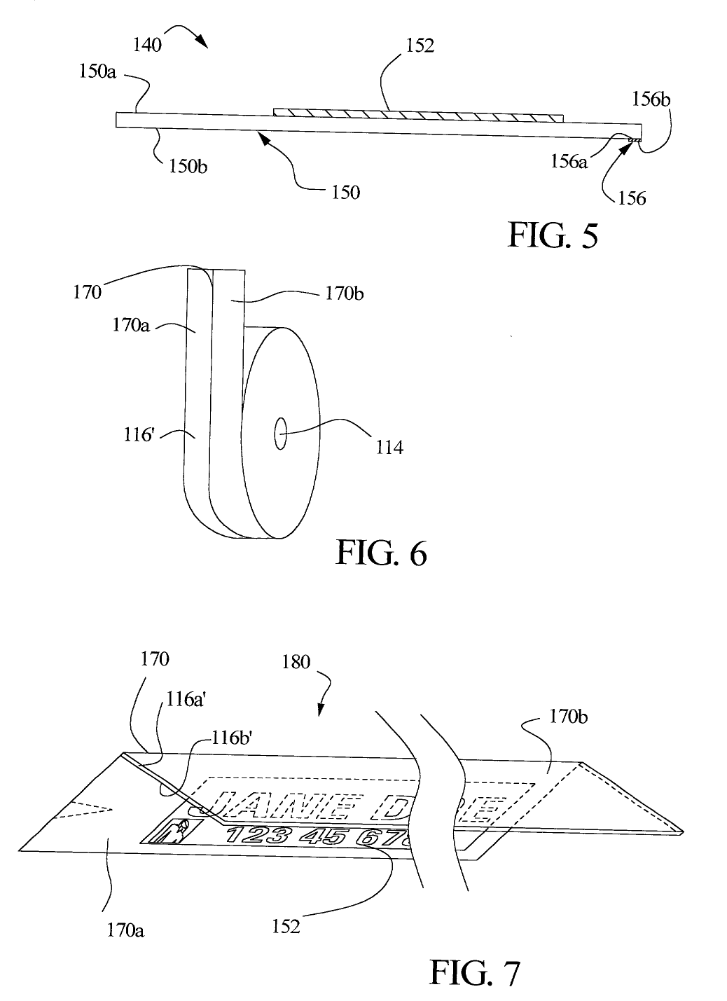

FIG. 5 illustrates in side view a newly printed bracelet 140 according to the present invention. In FIG. 5, a strip 150 of media 116 bears on its upper-facing (in the view of FIG. 5) surface 150a printed indicia 152 according to a specific identification bracelet 140, i.e., text and/or imaging for an individual for whom this bracelet 140 has been prepared. The lower-facing (in the view of FIG. 5) surface 150b carries a clasp 156. In the particular embodiment illustrated in FIG. 5, clasp 156 comprises a double sided adhesive 156a and backing sheet 156b. As may be appreciated, one surface of adhesive 156a adheres to surface of 150b of media strip 150 and the backing strip 156b protects the other adhesive surface against inadvertent contact. Joining bracelet 140 end-to-end in a bracelet or loop structure facilitates attachment to a user's limb. A clasp joining together the ends of bracelet 140 gives the resulting identification tag a degree of permanence. Typical hospital identification tags must be cut for removal. In addition, other forms of identification tags also must be “destroyed” upon removal, making it so the identification tag cannot be transferred to another person. This is common in many applications including amusement parks, concerts, and the like. A clasp 156 may be attached to bracelet 140 at the time of applying a bracelet to a user. In other words, a supply of double-sided segmented or precut adhesive tape is used in conjunction with mounting bracelet 140 to a user's limb. In the alternative, an automated form of cutter/punch 130 can concurrently sever a strip 150 from media 116 and attach a clasp 156 thereto.

To attach the identification bracelet 140 to a user, backing sheet 156b is removed from adhesive 156a and media strip 150 is wrapped around a limb, e.g., wrist or ankle, with print imaging 152 facing outward. Adhesive 156a is then coupled to surface 150a of media strip 150 to thereby capture the user's limb within the identification bracelet structure formed thereby. By selecting a sufficiently strong adhesive 156a in relation to the material strength of media 116, bracelet 140 may be made non-removable without detected degradation. In other words, by adhering strongly with adhesive 156a the bracelet 140 when attached about a wearer's limb cannot be removed without also tearing or degrading the structure of bracelet 140 and, thereby, indicating unauthorized use thereof.

In the alternative, clasp 156 may take a variety of forms. For example, clasp 156 may be provided as a rivet structure passing through opposite ends of bracelet 140 as positioned around a user's limb. Thus, at the time of mounting bracelet 140 to a user, one simply encircles the user's limb and places a riveting tool in an appropriate position, e.g., at holes produced by cutter/punch 130, to join together opposite ends of bracelet 140 and thereby secure bracelet 140 about a user's limb. Other examples of clasp 156 may be selected according to the type of material used as media 116. For example, a plastic form of media 116 can be melted together or glued together to form a clasp at the time of attaching to a user's limb. In this manner, the attachment becomes “permanent” in that such a bracelet 140 could not be removed without significantly degrading or destroying completely the bracelet 140.

Thus, a bracelet 140 generally in the form of a strip is produced by use of module 100 in conjunction with a conventional printer 20. Bracelet 140 production requires little individual manipulation other than at cutter/punch 130. Depending on the particular implementation of cutter/punch 130, however, such production could be fully automated by a cutter/punch 130 automatically cutting media 116 into appropriate length segments for use as an inventory of pre-printed bracelet. Individual manipulation always occurs, however, at the time of mounting bracelet 140 to a user. Individual bracelet 140 manipulation, inherent in applying identification bracelets to individual users, cannot be avoided entirely. Individual manipulation of an identification bracelet 140 can be reduced under the present invention as compared to conventional methods of producing identification bracelets. As may be appreciated, mass production of bracelets 140, each including print indicia 152 specific to individual users, occurs at relatively little expense. Media strip 150 can take the form of a variety of materials, ranging from simple paper-form media to more resilient media such as plastic or plasticized media. In some cases, media may be adapted in composition or by coating to better receive, i.e., have a greater affinity for, ink as projected from inkjet print head 21 of printer 20. For example, media strip 150 provided as plastic material may be chemically treated or “coated” to better receive inkjet ink as by hydrophilic coatings as are known in the art.

FIG. 6 illustrates a more complex form of media 116, indicated as media 116′. In FIG. 6, media 116′ is provided in reel-form on a spool 114. Thus, media 116′ feeds through printer 20 as does media 16,i.e., originating from module 100 as described above. Media 116′ differs, however, in its laterally bifurcated structure. More particularly, media 116′ includes along its length a foldable midline 170. Midline 170 divides a left side 170a and a right side 170b of media 116′. Generally, media 116′ is a plastic material of sufficient durability to serve as, for example, a hospital identification bracelet 180. Media 116′ may be provided as transparent media whereby, as described more fully hereafter, print imaging is visible therethrough.

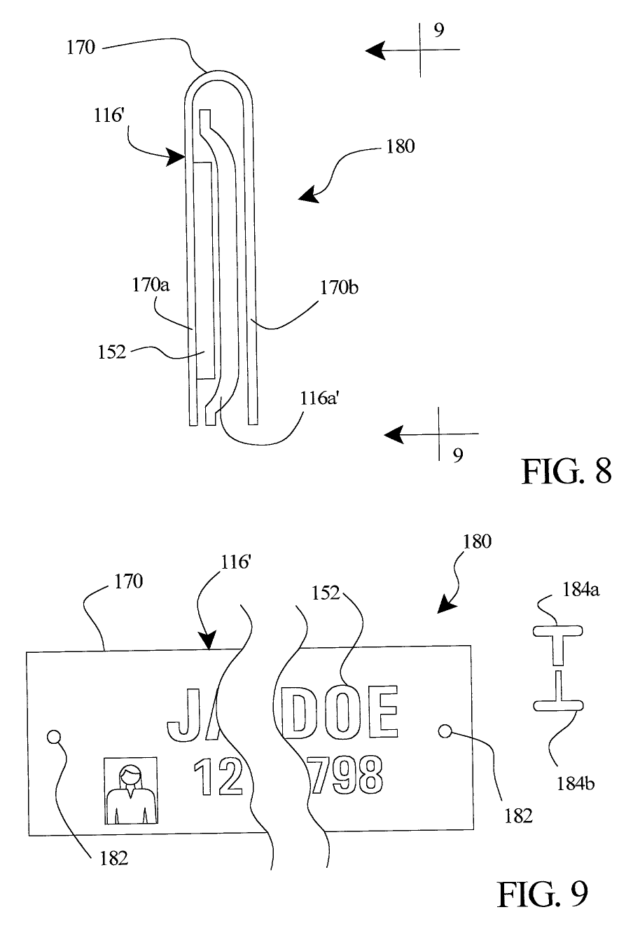

FIG. 7 illustrates a segment of media 116′ as output from printer 20, i.e., originating from module 100, and prior to final assembly to serve as a hospital identification bracelet 180. FIGS. 8 and 9 illustrate end and face views of bracelet 180 after final assembly and ready for application to a user's limb, i.e., ready to be attached as a loop formation about a user's wrist or ankle. Generally, left side 170a includes a coating to improve the ability of media 116′ to receive ink from inkjet print head 121. For example, left side 170a may be coated with a hydrophilic coating better receiving print imaging thereon, i.e., in relation to ordinary plastic materials. As may be appreciated, most transparent plastic materials do not suitably receive the water-based ink formulations typically found in inkjet ink formulations. Thus, a hydrophilic coating applied to left side 170a allows application of print imaging 152 thereon. Preferably, the hydrophilic coating applied to left side 170a is applied to the inner surface of side 170a such that when a segment of media 116′ folds along its fold line 170, print imaging 152 is captured between left side 170a and right side 170b. A transparent media 116′, therefore, makes print imaging 152 visible even though captured between sides 170a and 170b. This protects print imaging 152 against smudging or degradation due to abrasion. As discussed more fully hereafter, capturing print imaging 152 behind such transparent 116′ protects print imaging 152 against water damage. As such, the resulting bracelet 180 including print imaging 152 captured therein enjoys significant water-fastness as well as excellent protection against water damage to print imaging 152. Right side 170b includes an adhesive layer 116a′ captured between the body of media 116a′ and a waxy back sheet 116b′.

Thus, media 116′ feeds through printer 20 and receives on left side 170a print imaging 152. Upon exit from printer 20, a user can operate cutter/punch 130 to sever a segment of media 116′ as a bracelet 180 as illustrated in FIG. 7. Alternatively, the user can skip any individual bracelet 180 manipulation at the time of producing an inventory of bracelets 180 maintained in sequence and storable in reel-form. For example, a takeup reel could be used to collect output from printer 20. Furthermore, under such use of the present invention it is suggested that a perforated media 116 be employed to provide convenient separation of bracelets 180, i.e., by manually tearing bracelets 180 from an inventory of bracelets 180 stored in, for example, reel-form. Furthermore, cutter/punch 130 can be a more sophisticated device automatically severing bracelets 180 into an inventory of individual bracelets 180 as output therefrom. Alternatively, an inventory of bracelets 180 previously produced and stored in reel-form could be dispensed from a simple apparatus resembling a tape dispenser with a serrated edge for tearing bracelets 180 from the inventory of bracelets 180 held thereby. A sensor may be used to detect the lateral position of media 116′ within printer 20 and thereby suitably position print head 21 and apply print imaging to media 116′. Bracelet 180 is then prepared for use by removing the waxy back sheet 116b′ from adhesive layer 116a′ on side 170b. Bracelet 180 is then folded along line 170 as indicated in FIG. 7. This captures print imaging 152 between sides 170a and 170b (FIG. 8) thereby protecting it against water damage and abrasive degradation. Bracelet 180 is then ready for use, i.e., ready for attachment to a patient's wrist. More particularly, bracelet 180 includes at each end thereof an aperture 182. As may be appreciated, bracelet 180 wraps around a users limb. With apertures 182 aligned, a rivet top 184a and a rivet bottom 184b pass through apertures 182 and upon collapse, i.e., upon crushing together rivet top 184a and rivet bottom 184b, bracelet 180 forms a relatively permanent loop structure about a user's limb. As may be appreciated, such a structure cannot be removed without apparent damage or visible degradation. As such, bracelet 180 enjoys a high degree of security against unauthorized use. Despite this significant ability, bracelet 180 may be produced using substantially conventional inkjet printing apparatus.

Attachment of bracelet 180 to a user, however, may take a variety of forms. For example, a double-sided adhesive tape may be used as illustrated in FIG. 5 for bracelet 140. As noted above, a rivet may be placed through opposite ends of bracelet 180 when suitably positioned, i.e., encircling a user's limb, to capture the user's limb within the resulting annular structure. As may be appreciated, by using a rivet form of clasp and a plastic form of media 116′, a high degree of security results. More particularly, bracelet 180 provided in a plastic-form media 116′ and a rivet-form clasp cannot be removed from the user without suffering visible degradation. Accordingly, bracelet 180 enjoys a high degree of security in use. In other words, bracelet 180 offers a highly reliable indication of identification because once properly attached to the appropriate individual an identification bracelet 180 cannot be removed and reattached in unauthorized fashion to another individual without visibly apparent damage. An additional suggested form of clasp applicable under the present invention includes a “one-way” tie-strap, i.e., a ratcheting buckle preventing unbuckling without cutting the supporting strap thereof.

Identification tag bracelet need not be a fixed-length bracelet. More particularly, given measurement data concerning the intended identification tag user, i.e., a circumference for selected size indicator for the user's limb, such information could be incorporated into an identification tag printing operation under the present invention whereby, in addition to application of print imaging unique to a particular individual, the length of an identification bracelet produced for that individual corresponds to the individual's limb circumference or selected limb size designation. In this manner, the bracelet attaches in a more closely-fitting fashion, as well as conserves media used in the production thereof.

Alternatively, fixed length bracelet 140 and 180 segments can be provided by incorporating into media 116 and 116′ predefined sections established by lateral perforations distributed along the length of media 116 and 116′. In other words, media 116 and 116′ may be provided as a series of predefined length segments separated manually at laterally disposed perforations provided therealong.

Thus, an improved method of producing identification tags has been shown and illustrated. The subject matter of the present invention proposes use of an infeed tray specially adapted for feeding reel-form stock through a conventional printer. As such, the present invention facilitates mass production of identification tags using a conventional printer. Strip-form identification tags produced in accordance with the present invention may take a variety of forms, including a simple strip-form identification bracelet and a more complex strip-form identification tag having greater security features as necessary for a particular application.

While illustrated herein as a “strip-form” identification tag, it will be understood that identification tags produced in accordance with the present invention may be produced in many selected dimensions. Thus, while providing significant utility as a strip-form identification bracelet, the present invention also produces conventional-sized labels as provided by reel-form stock.

Many examples of cutter 130 may be implemented such as the simple pivoting shearing blade as commonly seen in elementary school classrooms, the transversely moved shearing wheel as typically seen on paper cutters in small businesses and on larger format roll-fed printers and plotters, transversely moving slitting blades, also called “razor blades”, thin serrated tearing cutters, as seen on adhesive tape dispensers and on household aluminum foil dispensing boxes, and vertically moving blades such as found on hand-held embossed strip labelers. All of these are well-known and may be either manually or automatically actuated.

If a cutter/punch 130 combination is desired, then vertically reciprocating or rotary punches and shears commonly used in strip form sheet metal processes or the die cutting industry may be quite easily adapted for use as cutter 130 in a printer context.

Motive force for an automatically actuated cutter/punch 130 could be provided by a dedicated electric motor within the module, by deriving motion from the printer by means of a frictional wheel within the module held in contact with the printer's feed roller 22, or by utilizing the motion of the media 116′.

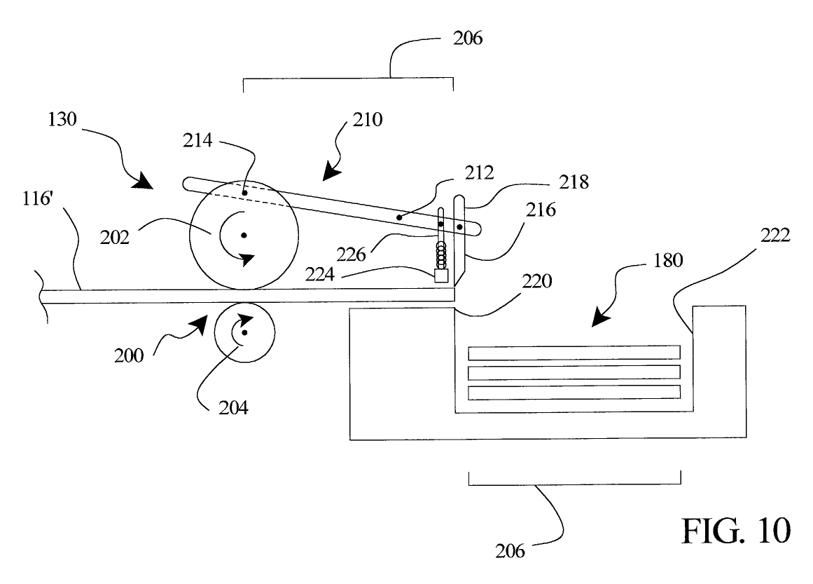

FIG. 10 illustrates schematically one suggested form of cutter 130. In FIG. 10, media 116′ moves into cutter 130 at a nip 200. At nip 200, media 116′ is captured between an upper roller 202 and lower roller 204. Generally, upper roller 202 rotates once for every bracelet 180 severed from media 116′. Thus, lower roller 204 serves as a pinch or as a drive roller relative to nip 200. In any case, the circumference of upper roller 202 is selected to correspond to bracelet 180 length 206. A pivot arm 210 pivots about a stationary pivot point 212. One end of arm 210 is pinned to upper roller 202 at rotary coupling 214. The opposite end arm 210 couples to a cutter blade 216 at pin coupling 218. Thus, as roller 202 rotates cutter blade 216 reciprocates up and down. The travel path for cutter blade 216 includes a downward plunge past cutter block edge 220. As may be appreciated, media 116′ passes edge 220, and for every downward plunge of cutter blade 216, is cut into a bracelet 180. An inventory of bracelets 180 accumulates in output tray 222. Media 116′ moves continuously into cutter 130 according to printing operations as described herein above. Thus, media 116′ at cutter block edge 220 must be held stationary during the brief time in which cutter blade 216 plunges through media 116′ and severs a length 206 segment of media 116′ as a bracelet 180. To this end, stop block 224 is positioned just upstream from cutter blade 216 and cutter block edge 220. Lever arm 210 couples to block 224 through a spring bias 226. This maintains block 224 normally ahead of cutter blade 216 as cutter blade 216 makes a downward plunge. Thus, block 224 first engages media 116′ prior to the onset of cutting action by cutter blade 216. In this manner, that portion of media 116′ at edge 220 remains stationary during the downward cutting plunge of cutter blade 216. As cutter blade 216 makes its upward motion following a cut, block 224 lifts from and frees media 116′ for continued forward travel. In other words, during a cut by cutter blade 216 media 116′ just behind block 224 briefly buckles as it is held back from further forward motion by block 224.

It will be appreciated that the present invention is not restricted to the particular embodiment that has been described and illustrated, and that variations may be made therein without departing from the scope of the invention as found in the appended claims and equivalents thereof.

What is claimed is:

1. An inkjet printer media input module comprising:
a mounting structure attachable to an inkjet printer; and
a media support coupled to said mounting structure, said media support adapted to hold and dispense a supply of reel-form media, said media support being positioned to present a distal end of reel-form media, when held thereby, to a media feed mechanism of said inkjet printer.

2. An inkjet printer media input module according to claim I wherein said mounting structure mounts to said printer at an input tray mounting site of said printer.

3. An inkjet printer media input module according to claim 1 wherein said module further comprises a reel-form media at said media support.

4. An inkjet printer media input module according to claim 3 wherein said reel-form media comprises:
a planer substrate coiled to form a roll structure, said substrate including a first lateral side and a second lateral side,
a longitudinally disposed fold line being interposed between said first lateral side and second lateral side, said second lateral side bearing an adhesive.

5. An inkjet printer media input module according to claim 4 wherein said first lateral side is adapted to receive print imaging.

6. An inkjet printer media input module according to claim 5 wherein said print imaging is inkjet print imaging.

7. An inkjet printer media input module according to claim 4 wherein said fold line is a laterally centered midline.

8. An inkjet printer media input module according to claim 4 wherein said substrate is a plastic substrate.

9. An inkjet printer media input module according to claim 1 wherein said module further comprises a cutter.

10. An inkjet printer media input module according to claim 9 wherein said cutter is adapted to sever length sections of reel-form media.

11. In combination:
reel-form media organized as a roll structure and having a free distal end;
an inkjet printer, said inkjet printer including a media feed mechanism; and
a media module mounted to said inkjet printer and holding therein said reel-form media, said media module presenting said distal end of said media to said feed mechanism of said inkjet printer.

12. A combination according to claim 11 wherein said media module mounts to said inkjet printer at an input tray mounting site of said inkjet printer.

13. A combination according to claim 11 wherein said reel-form media comprises strip-form media.

14. A combination according to claim 11 wherein said reel-form media comprises: a planer substrate coiled to form a roll structure, said substrate including a first lateral side and a second lateral side, a longitudinally disposed fold line being interposed between said first lateral side and second said lateral side, said second lateral side bearing an adhesive.

15. A combination according to claim 14 wherein said first lateral side is adapted to receive print imaging.

16. A combination according to claim 15 wherein said print imaging is inkjet print imaging.

17. A combination according to claim 14 wherein said fold line is a laterally centered midline.

18. A combination according to claim 14 wherein said substrate is a plastic substrate.

19. A combination according to claim 18 wherein said plastic substrate bears a coating improving reception of said print imaging.

20. A combination according to claim 19 wherein said coating is a hydrophilic coating.

21. A combination according to claim 18 wherein said plastic substrate is transparent.

22. A combination according to claim 11 further comprising a cutter.

23. An identification tag comprising:
a section of substrate having a given longitudinally disposed length and given laterally disposed width, said substrate being folded along a longitudinally disposed fold line, said fold line separating a first lateral side and second lateral side;
print imaging as identification indicia and applied to said first lateral side; and
adhesive applied to said second lateral side.

24. An identification tag according to claim 23 further comprises a clasp joining first and second ends of said section as a loop structure.

25. An identification tag according to claim 23 wherein said first and second lateral sides capture therebetween said print imaging and said adhesive.

26. An identification tag according to claim 23 wherein said given length is a selected bracelet length corresponding to a selected user limb circumference.

27. An identification tag according to claim 26 wherein said identification tag includes a clasp and attaches to a user as a limb bracelet.

28. An identification tag according to claim 23 wherein said first side is adapted by hydrophilic coating to better receive print imaging thereon.

29. An identification tag according to claim 23 wherein said print imaging is inkjet print imaging.

30. An identification tag according to claim 23 wherein said fold line is a laterally centered midline.

31. An identification tag according to claim 23 wherein said substrate is a plastic substrate.

32. An identification tag according to claim 31 wherein said plastic substrate bears a coating adapted to improved reception of said print imaging.

33. An identification tag according to claim 32 wherein said coating is a hydrophilic coating.

34. An identification tag according to claim 31 wherein said plastic substrate is transparent.
